(19) United States
(12) Patent Application Publication
(10) Pub. No.: US 2016/0205731 A1
(43) Pub. Date: Jul. 14, 2016

(54) HOT PLUG MODULE AND DRIVER FOR ILLUMINATING DEVICE AND ILLUMINATING DEVICE

(71) Applicant: OSRAM GMBH, München (DE)

(72) Inventor: Quan Zhang, Shenzhen (CN)

(21) Appl. No.: 14/912,950

(22) PCT Filed: Aug. 6, 2014
(86) PCT No.: PCT/EP2014/066879

§ 371 Date: Feb. 19, 2016

(30) Foreign Application Priority Data
Aug. 21, 2013 (CN) 201310367771.X

(51) Int. Cl. H05B 33/08

(52) U.S. Cl. CPC H05B 33/089; H05B 33/0815

(57) ABSTRACT

Various embodiments may relate to a hot plug module for an illuminating device, including a detection unit for detecting a hot plug state to obtain a detecting state, and an impedance adjusting unit for adjusting an impedance state of the hot plug module in accordance with the detecting state, and wherein the impedance adjusting unit includes an impedance conversion unit whose impedance can be converted, and a conversion drive unit converting the impedance of the impedance conversion unit in accordance with the detecting state to adjust the impedance state. Further, various embodiments relate to a driver for an illuminating device and an illuminating device.

### RELATED APPLICATIONS

The present application is a national stage entry according to 35 U.S.C. §371 of PCT application No.: PCT/EP2014/066879 filed on Aug. 6, 2014, which claims priority from Chinese application No.: 201310367771.X filed on Aug. 21, 2013, and is incorporated herein by reference in its entirety.

### TECHNICAL FIELD

Various embodiments relate to a hot plug module and a driver for an illuminating device and the illuminating device.

### BACKGROUND

LED illumination technology has advantages such as high illumination intensity, long lifetime, high efficiency and energy saving, and has been widely used at present, and in particular, illuminating devices with LED illumination technology are used in both indoor environment such as stores or offices and outdoor environment such as building sites or roadsides. In a prior LED illuminating device, a constant current LED module is generally driven by a constant current LED driver with a direct current, however, since the driver circuit has a larger output voltage in an open circuit state than in a state where the circuit is connected with a load, during hot plugging of a light emitting unit such as an LED lamp, the light emitting unit is damaged due to the overwhelming output voltage, and the application range of the circuit is greatly limited because it cannot support hot plug.

A related art solution proposes that a double stage converter circuit is designed in the constant current drive circuit, wherein the first stage is used for power factor correction, AC-DC voltage conversion and primary-secondary insulation, and the second stage is used to perform buck conversion of a DC input voltage to a DC output voltage and supply power to a light emitting unit of an illuminating device. Though the solution can be employed in hot plug technology, the cost is increased and a more compact structure cannot be provided because of the use of a buck converter. Moreover, although the circuit so designed can greatly reduce an inrush current during hot plug, the inrush current cannot be fully damped, and thus a light emitting unit connected to the drive circuit may be damaged. Furthermore, detection delay and turn off delay during hot plugging occur in the drive circuit due to the buck converter, thus the light emitting unit may be still damaged by the inrush current.

### SUMMARY

Various embodiments provide a novel hot plug module and a drive circuit for an illuminating device, and an illuminating device using the hot plug module and the drive circuit. The hot plug module designed according to various embodiments has a compact and simple circuit design, and also has a good compatibility and can be effectively compatible with any constant current LED driver. Moreover, the hot plug module has a very rapid response speed and can effectively control an inrush current that may be output to a light emitting unit and effectively restrict the current so that the light emitting unit is not damaged due to the inrush current.

Various embodiments provide a hot plug module for an illuminating device including: a detection unit for detecting a hot plug state to obtain a detecting state; and an impedance adjusting unit for adjusting an impedance state of the hot plug module in accordance with the detecting state, and wherein the impedance adjusting unit includes an impedance conversion unit whose impedance can be converted; and a conversion drive unit converting the impedance of the impedance conversion unit in accordance with the detecting state to adjust the impedance state. By adjusting the impedance of the impedance conversion unit, the impedance adjusting unit enables the module to be adapted to a hot plug-in or hot plug-out state and provides the possibility of controlling and adjusting an output current of the circuit in these states to adjust the inrush current.

According to various embodiments, the conversion drive unit includes: a high impedance drive unit configured so that the impedance conversion unit is adjusted to be in high impedance; and a low impedance drive unit configured so that the impedance conversion unit is adjusted to be in low impedance. The high impedance drive unit can adjust the impedance of the module to high impedance based on a result of detection by the detection unit so as to suppress an input current in, for example, a hot plug-in state to finally suppress the inrush current, and the low impedance drive unit can adjust the impedance of the module to low impedance so as to recover the output current in, for example, a hot plug-out state.

According to various embodiments, the detecting state includes a first state characterizing no load, a second state characterizing hot plug-in, and a third state characterizing hot plug-out. Such design can effectively meet the requirements of various states where the circuit is placed during hot plugging so as to ensure the stability and compatibility of the drive circuit.

In various embodiments, the impedance conversion unit includes: a high impedance unit activated by the conversion drive unit in accordance with the second state and the third state; and a low impedance unit activated by the conversion drive unit in accordance with the first state and the second state, and sequentially deactivated and activated in accordance with the third state. The high impedance unit and the low impedance unit can be adapted to various states during the hot plugging to adjust an internal impedance of the drive circuit so as to change an output current to suppress the inrush current or recover the output current of the drive circuit.

According to various embodiments, the detection unit includes: a buffer unit connected to a light emitting unit; and a hot plug detection unit controlling the conversion drive unit based on a signal supplied by the buffer unit to adjust the impedance conversion unit. During hot plug-in or hot plug-out, the buffer unit can temporally block a transient change of the output current of the drive circuit and supply a signal to the hot plug detection unit to adjust the impedance conversion unit so as to change the internal impedance of the drive circuit.

In various embodiments, the high impedance unit includes at least one electronic device with high impedance. The electronic device with high impedance can increase the impedance of the circuit during for example hot plug-in to decrease the output current.

In various embodiments, the electronic device is configured as any one of an NTC resistor, a PTC resistor and a semiconductor device. Such electronic device can efficiently increase the internal impedance of the circuit during, for example, hot plug-in to decrease the output current.

In various embodiments, the low impedance unit includes at least one controllable switching device. Therefore, the controllable switching device can be turned on and conducted by the low impedance drive unit after, for example, hot plug-out to reduce the internal impedance of the circuit so that the output circuit is recovered to an original large value.

In various embodiments, the controllable switching device is configured as any one of a power MOSFET, a bipolar transistor and an IGBT. Such device can be effectively controlled by the low impedance drive unit and have small impedance after conducted to facilitate the adjustment of the internal impedance of the drive circuit.

In various embodiments, the high impedance drive unit includes a second transistor, a second resistor and a third resistor, wherein the second transistor has a control electrode connected between the second resistor and the third resistor, and a reference electrode connected to ground. On/off of the second transistor can be effectively controlled by dividing the voltage by the second resistor and the third resistor, and a value of the output current damped by the high impedance unit is defined by a ratio between the two resistors.

In various embodiments, the low impedance drive unit includes a first resistor and a first Zener diode, wherein the first resistor is grounded through the first Zener diode, and the second transistor has an operational electrode connected between the first resistor and the first Zener diode. On/off of the low impedance unit can be efficiently controlled by means of the first resistor and the first Zener diode.

In various embodiments, the hot plug detection unit includes a third diode and/or a first capacitor, wherein the third diode and/or the first capacitor is grounded through the conversion drive unit. At the time of, for example, hot plug-in, the third diode supplies a signal to the high impedance drive unit through the buffer unit to activate the high impedance unit. Moreover, at the time of, for example, hot plug-out, the third diode and the first capacitor can reset the buffer unit and at the same time supply a signal to the high impedance drive unit to activate the high impedance unit.

In various embodiments, the hot plug detection unit further includes a second diode, wherein a cathode of the third diode is connected to a cathode of the second diode and grounded through the second diode.

In various embodiments, the buffer unit includes a first inductance, wherein the first inductance is grounded through a controllable switching device. The inductance can efficiently block the transient change of the output current during hot plugging and be reset at the time of, for example, hot plug-out so as to be ready for next hot plug-out operation.

Various embodiments further provide a driver for an illuminating device including a hot plug module described above. Such driver can effectively meet and adapt to various circuit states during hot plugging to ensure the stability and reliability of the illuminating device.

In various embodiments, the driver further includes a first detection resistor and an output capacitor, wherein each of the first detection resistor and the output capacitor has an end connected to ground.

Various embodiments also provide an illuminating device including at least one light emitting unit, and a hot plug module described above and/or a driver described above. Such illuminating device has a reliable and rapidly responsive hot plug function and can effectively resist damage which may be caused by an inrush current during hot plugging.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a diagram showing functional modules of a hot plug module according to the present disclosure,

FIG. 2 is a diagram showing a specific circuit of an illuminating device with a hot plug module according to the present disclosure, and

FIGS. 3A-3B, 4A-4B, 5A-5B, 6A-6B, 7A-7C, 8A-8B, and 9A-9B illustrate schematic diagrams for respective steps during hot-plug in and hot-plug out and corresponding waveforms for specific signals during the respective steps.

### DETAILED DESCRIPTION

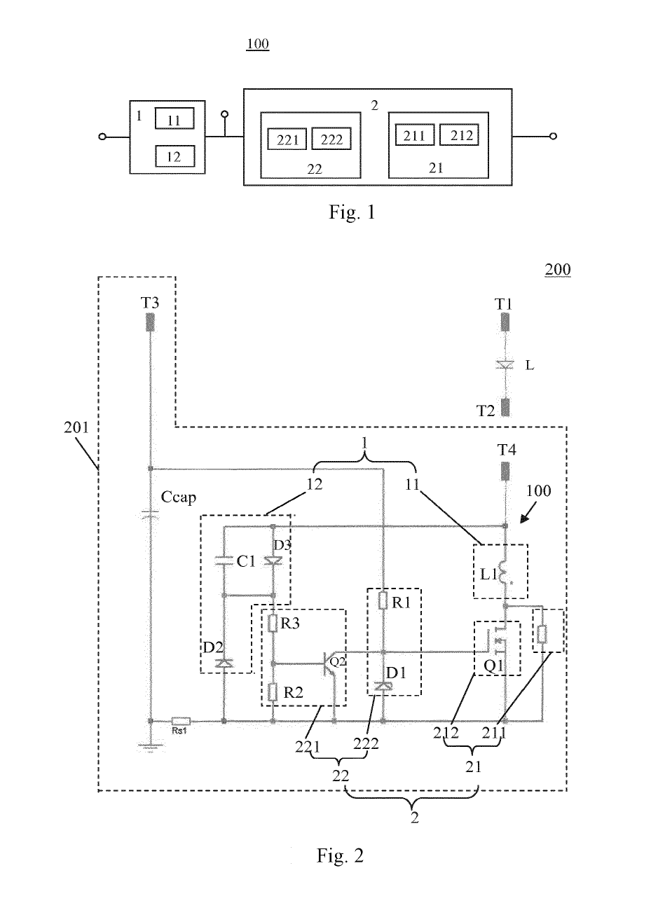

FIG. 1 illustrates a diagram showing functional modules of a hot plug module 100 according to the present disclosure. As shown in FIG. 1, the hot plug module 100 includes a detection unit 1 and an impedance adjusting unit 2 which adjusts (e.g., increases or decreases) an impedance of a drive circuit in accordance with a hot plug state S, for example a hot plug-in state, a hot plug-out state or a no-load state, detected by the detection unit 1. The hot plug module 100 with such design can be connected to and compatible with other prior constant current drive circuits and a light emitting unit designed as for example an LED to effectively provide hot plug function.

Specifically, the detection unit 1 is designed to include a buffer unit 11 and a hot plug detection unit 12, the buffer unit 11 can be connected directly to, for example, the light emitting unit and supply a signal to the hot plug detection unit 12 when being connected with the light emitting unit, and the hot plug detection unit 12 controls a conversion drive unit 22 disposed in the impedance adjusting unit 2 based on the signal to finally adjust an impedance conversion unit 21 of the impedance adjusting unit 2 so as to change an internal impedance of the drive circuit.

Moreover, the impedance adjusting unit 2 is further provided with a high impedance drive unit 221 and a low impedance drive unit 222, the hot plug detection unit 12 can control the high impedance drive unit 221 based on the detecting state S by the detection unit 1 in the case of for example hot plug-in to drive and activate a high impedance unit 211 disposed in the impedance conversion unit 21 to increase the impedance of the drive circuit; and in the case of for example hot plug-out, the low impedance drive unit 222 can turn off a low impedance unit 212 first so that the drive circuit has an increased impedance because of the high impedance unit 211, and after the hot plug-out operation is completed, the low impedance drive unit 222 drives and activates the low impedance unit 212 so that the high impedance unit 211 is turned off, and the internal impedance of the drive circuit is decreased. The high impedance unit 211 can be designed as a high impedance resistor 211 or any one of an NTC resistor, a PTC resistor and a semiconductor device, and the low impedance unit 212 can be designed as, but not limited to, any one of a power MOSFET, a bipolar transistor and an IGBT, and other electronic devices that can achieve similar or same effects can be also used in the present disclosure.

FIG. 2 illustrates a diagram showing a specific circuit of an illuminating device 200 with a hot plug module 100 according to the present disclosure. The illuminating device 200 includes a driver 201 and a light emitting unit L connected to the driver 201, wherein the driver 201 includes a hot plug module 100 described above, and the light emitting unit L has both terminals T1, T2 connected to respective both output terminals T3, T4 of the driver 201. Moreover, the driver 201 further includes an output capacitor Ccap and a first detection resistor Rs1 each of which has one end connected to ground and the other end connected to the hot plug module 100. Such hot plug module 100 can be compatible with any other prior constant current LED driver and provide excellent hot plug function. Such driver with the hot plug module 100 can be used in for example a drive circuit having a single output current detection resistor, a drive circuit having a plurality of output current detection resistors, and a drive circuit with phase cut control.

FIG. 2 shows only an illustrative embodiment of the present disclosure, and various modifications can be made to the present disclosure, for example, the present disclosure can be modified to have a single output path, a plurality of detection resistors for adjusting a current, and a phase cut dimming function.

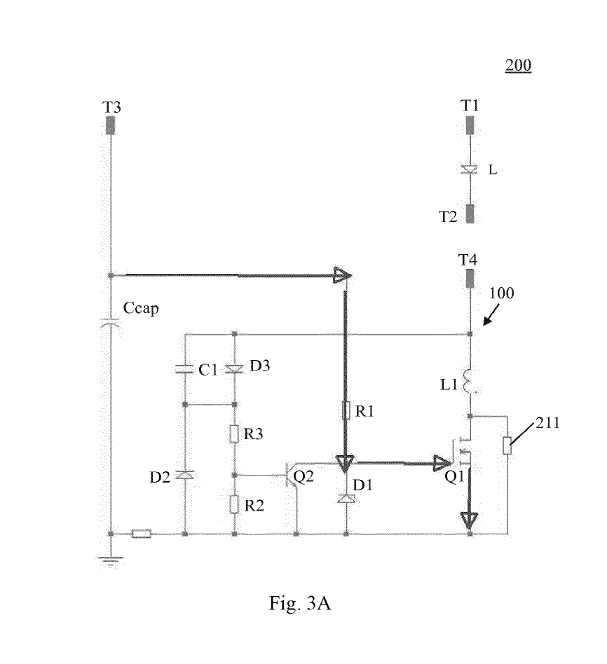

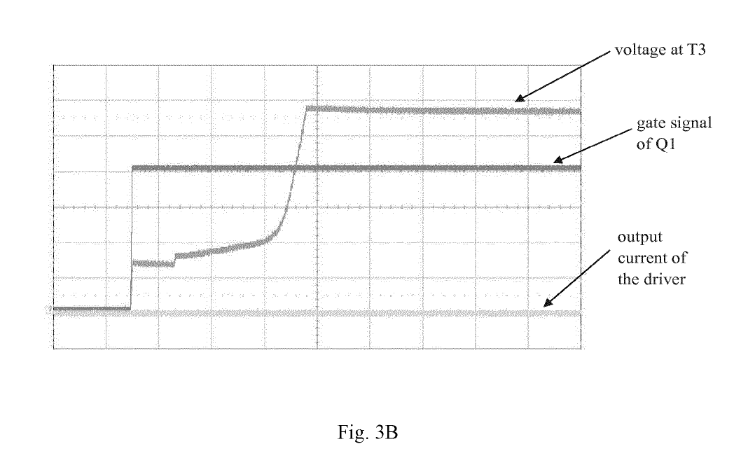

FIGS. 3A-3B, 4A-4B, 5A-5B, 6A-6B, 7A-7C, 8A-8B, and 9A-9B illustrate schematic diagrams for respective steps during hot-plug in and hot-plug out and corresponding waveforms for specific signals during the respective steps, wherein the arrows in the figures schematically indicate the current flow direction and the crosses in the figures schematically indicate the component being switched off or disconnected.

While carrying out hot-plug in of the LED, the following steps are performed. As it is shown in FIG. 3A, before hot-plug in, which is in step 1, during which there is no load plugged in and the first transistor Q1 which is designed as a controllable switching device is turned on by voltage from terminal T3 through a first resistor R1. FIG. 3B shows waveforms for voltage signal at terminal T3, gate signal of the first transistor Q1 and output current of the driver. The first transistor Q1 can be designed as a field effect transistor MOSFET, or can be designed as for example a bipolar transistor or IGBT.

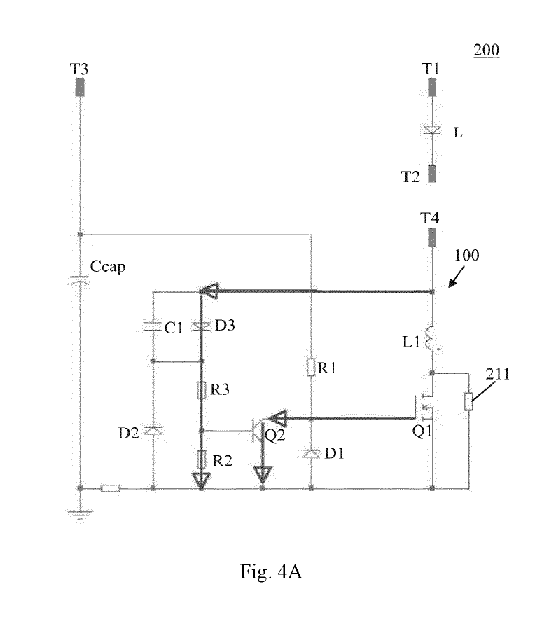

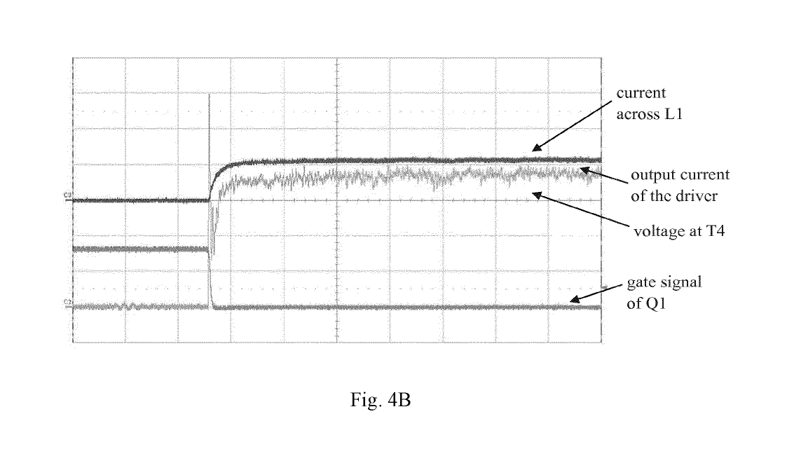

In step 2, at the instant of hot-plug in, as shown in FIG. 4A, a first inductance L1 maintains and blocks a transient change of the output voltage which will results in an inrush current. In this step, the first transistor Q1 is turned off by voltage from terminal 14 through a third diode D3, a third resistor R3, a second resistor R2 and a second transistor Q2, and the period thereof is determined by the base current of the second transistor and the gate capacitance of the first transistor, which could be 200 ns in current embodiment. During the period, i.e. 200 ns, the current across the first inductance L1 increases to an extent where the current is less than a maximum allowed LED inrush current. After the first transistor Q1 being turned off, the current across the first inductance L1 flows through the high impedance unit 211 instead of flowing through the first transistor Q1 so that there is a spike at terminal T4. The high impedance unit 211 is preferably embodied as a resistor or a positive temperature coefficient resistor PTC, a negative temperature coefficient resistor NTC, or any other semiconductor device controlled by an impedance state. FIG. 4B shows waveforms for voltage signal at terminal T4, gate signal of the first transistor Q1, current signal of the first inductance and output current of the driver, wherein the waveforms of the current across the first inductance L1 and output current of the driver are overlapped in most part.

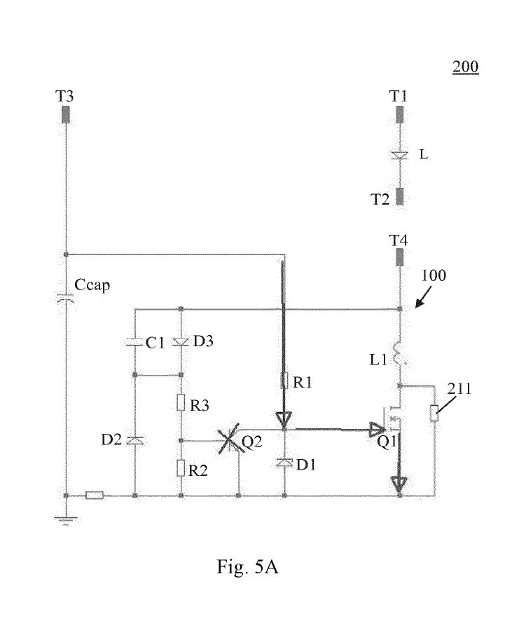

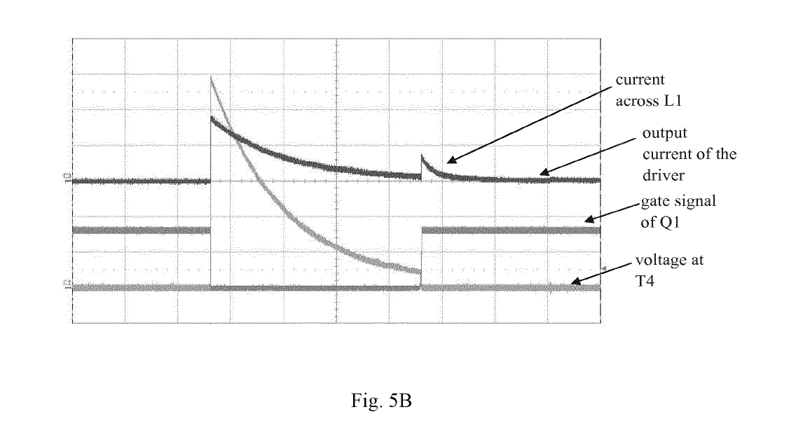

When the output voltage of the driver is being damped by the high impedance unit 211 after step 2, which is now in step 3, as shown in FIG. 5A, the voltage at terminal T4 keeps decreasing so that the second transistor Q2 begins to turn off. A threshold for turning off the second transistor Q2 is determined by the second resistor R2, the third resistor R3 and the second transistor Q2, wherein the threshold could be embodied as 2V, which is not too high to cause high inrush current. The first transistor Q1 is then turned on and the high impedance unit 211 is thus bypassed, whereby the driver can supply rated current to LED. FIG. 5B shows waveforms for voltage signal at terminal T4, gate signal of the first transistor Q1, the current across the first inductance and the output current of the driver, wherein the waveforms of the current across the first inductance L1 and output current of the driver are overlapped in most part.

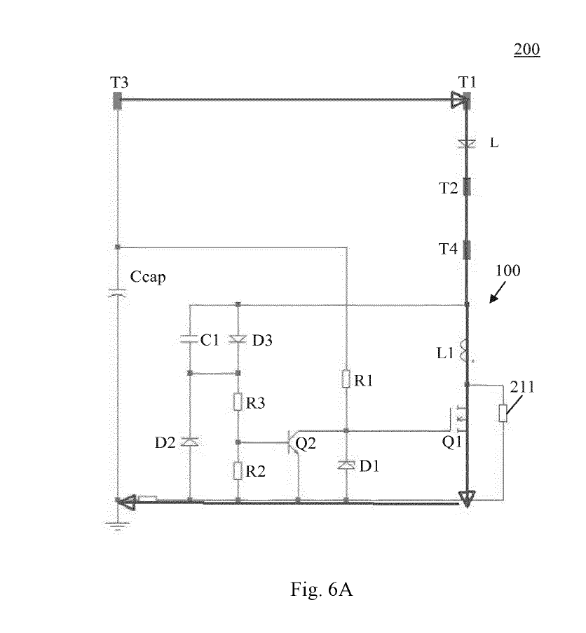

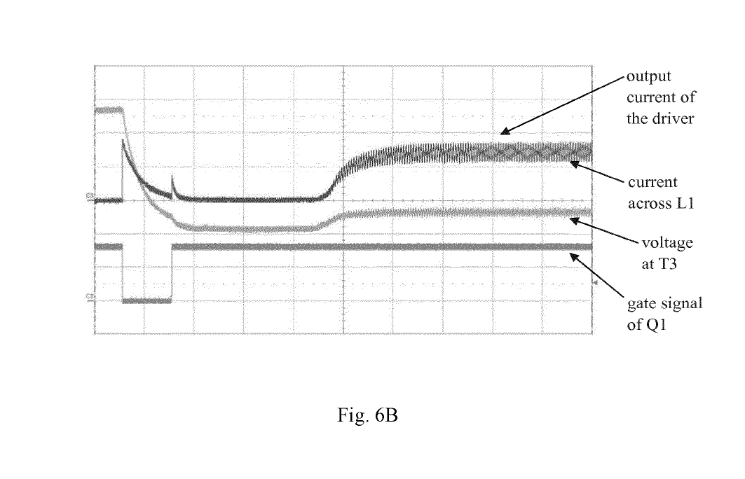

In step 4, FIG. 6A shows a schematic diagram when the output voltage of the driver has now been fully damped. A current flow is formed from the terminal T3 to the first detection resistor Rs1 through the LED, the first inductance and the first transistor, and the driver supplies rated current to the LED. FIG. 6B shows waveforms for voltage signal at terminal T3, gate signal of the first transistor Q1, the current across the first inductance and the output current of the driver, wherein the waveforms of the current across the first inductance L1 and output current of the driver are overlapped in most part.

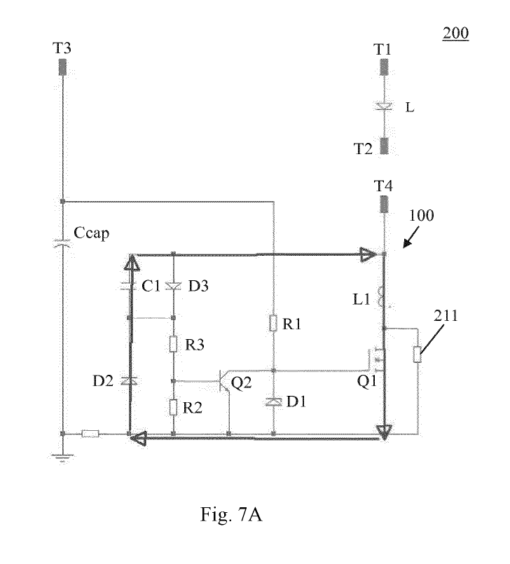

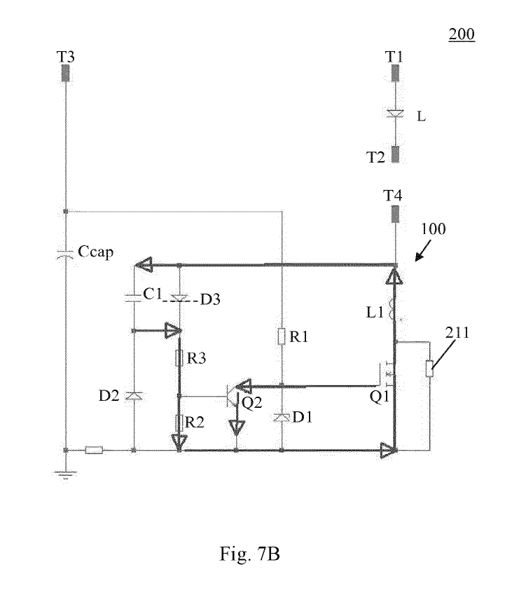

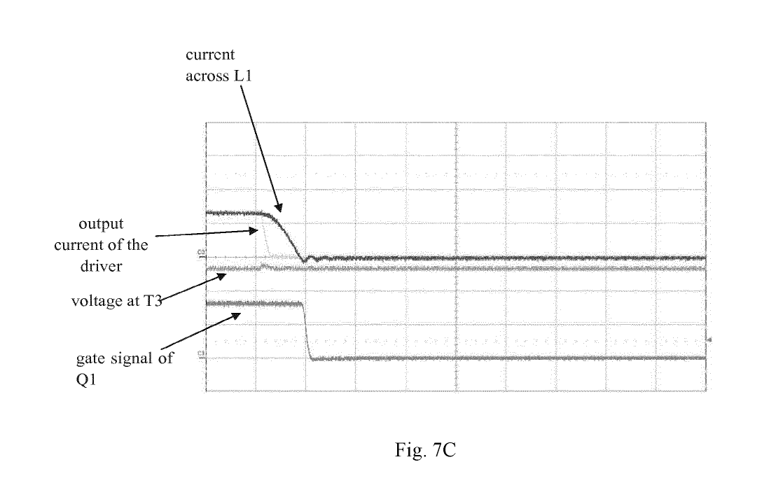

While hot-plug out of the LED is performed, the following steps are carried out. As it is shown in FIG. 7A-7B, in step 5, at the instant of hot-plug out, there are two phases for the operation of the driver. In phase 1, as shown in FIG. 7A, the first inductance L1 is reset through the first transistor Q1, the second diode D2 and the first transistor Q1, and the current in the first inductance is transferred to the first capacitor and stored in the capacitor in the form of its voltage, and the period thereof is derived as (¼)*[2*Pi*(L1*C3)̂0.5], and a period of 400 ns is embodied in current design, which is less than 1 microsecond, and even if, for example, a hot plug-in operation is performed before the first inductance L1 being completely discharged and reset, the inrush current is not generated because the voltage at the fourth terminal T4 cannot be changed within 1 microsecond. Further, in the first phase, although the first transistor Q1 keeps conducting and the first inductance L1 is not fully reset, the output voltage of the driver is held. In phase 2, after the first inductance L1 is fully reset, voltage from the first capacitor C1 turns on the second transistor Q2, and the first transistor Q1 is then discharged through the third resistor R3, the second resistor R2, the second transistor Q2, the body diode of the first transistor Q1 and the first inductance L1. In this phase, the first capacitor is also reset and is thus prepared for the next hot-plug in action. FIG. 7C shows waveforms for voltage signal at terminal T3, gate signal of the first transistor, the current across the first inductance L1 and the output current of the driver, wherein the waveforms of the current across the first inductance L1 and output current of the driver are overlapped in most part but the beginning part.

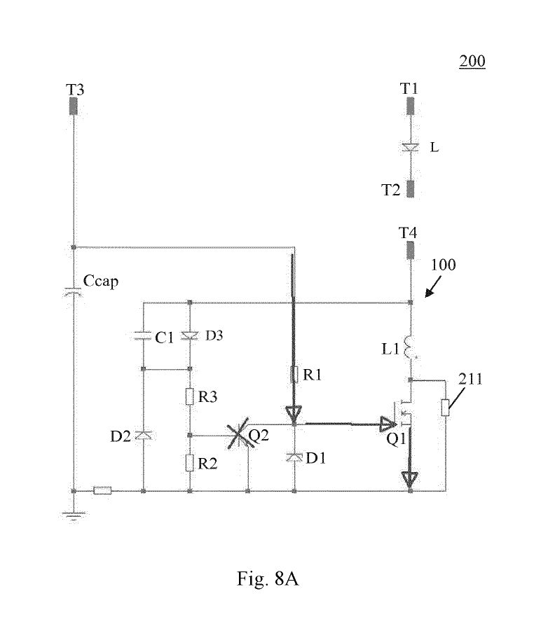

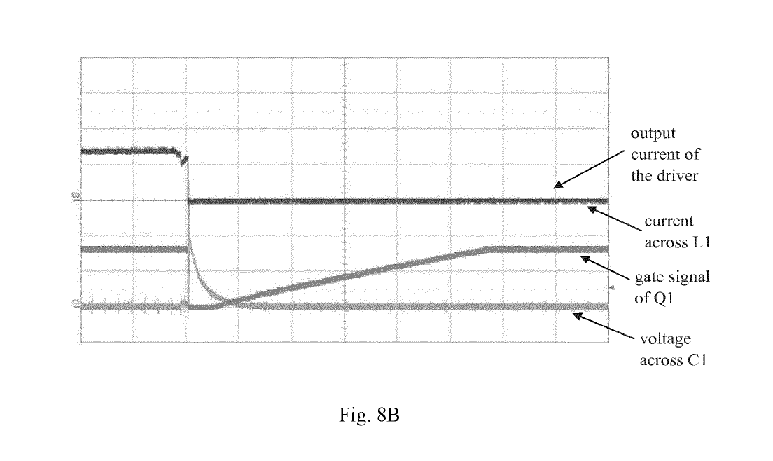

In step 6, after the first inductance L1 and the first capacitor C1 is fully reset, the first transistor Q1 turns on again by the voltage from the terminal T3 through the first resistor R1. FIG. 8A shows a schematic diagram regarding the step 6, and FIG. 8B shows waveforms for voltage signal of the first capacitor, the gate signal of the first transistor, the current across the first inductance and the output current of the driver, wherein the waveforms of the current across the first inductance L1 and output current of the driver are overlapped in most part.

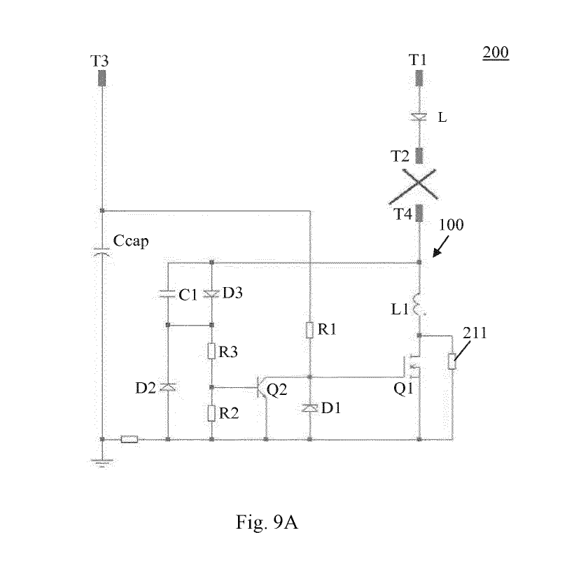

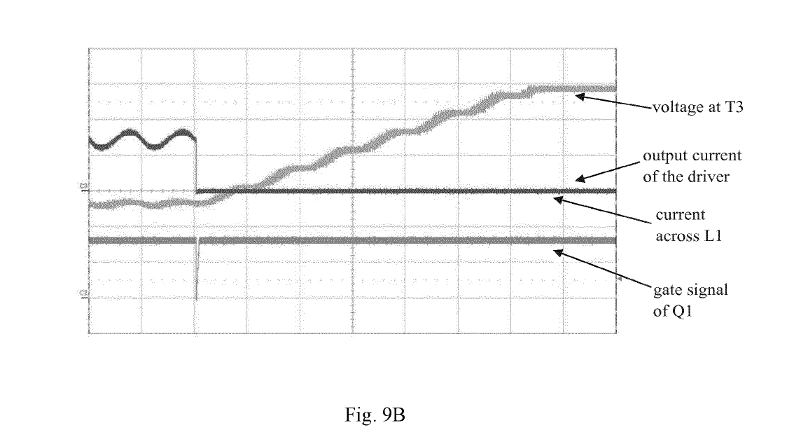

In step 7, the output voltage of the driver increases to an open load voltage, and the LED is fully separated from the driver, and the driver is prepared for next hot-plug in action. As shown in FIG. 9A, LED is disconnected with the driver. FIG. 9B shows waveforms for the voltage at terminal 13, gate signal of the first transistor Q1, current across the first inductance and the output current of the driver, wherein the waveforms of the current across the first inductance L1 and output current of the driver are overlapped in most part.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A hot plug module for an illuminating device, comprising:
a detection unit for detecting a hot plug state to obtain a detecting state; and
an impedance adjusting unit for adjusting an impedance state of the hot plug module in accordance with the detecting state,
wherein the impedance adjusting unit comprises
an impedance conversion unit whose impedance is converted; and
a conversion drive unit converting the impedance of the impedance conversion unit in accordance with the detecting state to adjust the impedance state.

2. The hot plug module according to claim 1, wherein
the conversion drive unit comprises:
a high impedance drive unit configured so that the impedance conversion unit is adjusted to be in high impedance; and
a low impedance drive unit configured so that the impedance conversion unit is adjusted to be in low impedance.

3. The hot plug module according to claim 1, wherein
the detecting state comprises a first state characterizing no load, a second state characterizing hot plug-in, and a third state characterizing hot plug-out.

4. The hot plug module according to claim 3, wherein
the impedance conversion unit comprises:
a high impedance unit activated by the conversion drive unit in accordance with the second state and the third state; and
a low impedance unit activated by the conversion drive unit in accordance with the first state and the second state, and sequentially deactivated and activated in accordance with the third state.

5. The hot plug module according to claim 1, wherein
the detection unit comprises:
a buffer unit connected to a light emitting unit; and
a hot plug detection unit controlling the conversion drive unit based on a signal supplied by the buffer unit to adjust the impedance conversion unit.

6. The hot plug module according to claim 4, wherein the high impedance unit comprises at least one electronic device with high impedance.

7. The hot plug module according to claim 6, wherein the electronic device is configured as any one of an NTC resistor, a PTC resistor and a semiconductor device.

8. The hot plug module according to claim 4, wherein the low impedance unit comprises at least one controllable switching device.

9. The hot plug module according to claim 8, wherein the controllable switching device is configured as any one of a power MOSFET, a bipolar transistor and an IGBT.

10. The hot plug module according to claim 2, wherein
the high impedance drive unit comprises a second transistor, a second resistor and a third resistor,
wherein the second transistor has a control electrode connected between the second resistor and the third resistor, and a reference electrode connected to ground.

11. The hot plug module according to claim 10, wherein
the low impedance drive unit comprises a first resistor and a first Zener diode,
wherein the first resistor is grounded through the first Zener diode,
and the second transistor has an operational electrode connected between the first resistor and the first Zener diode.

12. The hot plug module according to claim 5, wherein
the hot plug detection unit comprises a third diode and/or a first capacitor,
wherein the third diode and/or the first capacitor is grounded through the conversion drive unit.

13. The hot plug module according to claim 12, wherein
the hot plug detection unit further comprises a second diode,
wherein a cathode of the third diode is connected to a cathode of the second diode and grounded through the second diode.

14. The hot plug module according to claim 5, wherein
the buffer unit comprises a first inductance,
wherein the first inductance is grounded through a controllable switching device.

15. A driver for an illuminating device,
comprising a hot plug module
the hot plug module, comprising:
a detection unit for detecting a hot plug state to obtain a detecting state; and
an impedance adjusting unit for adjusting an impedance state of the hot plug module in accordance with the detecting state,
wherein the impedance adjusting unit comprises:
an impedance conversion unit whose impedance is converted; and
a conversion drive unit converting the impedance of the impedance conversion unit in accordance with the detecting state to adjust the impedance state.

16. The driver according to claim 15, wherein
the driver further comprises a first detection resistor and an output capacitor,
wherein each of the first detection resistor and the output capacitor has an end connected to ground.

17. An illuminating device, comprising:
at least one light emitting unit, and
a hot plug module and/or a driver comprising the hot plug module,
the hot plug module, comprising:
a detection unit for detecting a hot plug state to obtain a detecting state; and
an impedance adjusting unit for adjusting an impedance state of the hot plug module in accordance with the detecting state,
wherein the impedance adjusting unit comprises:
an impedance conversion unit whose impedance is converted; and
a conversion drive unit converting the impedance of the impedance conversion unit in accordance with the detecting state to adjust the impedance state.
